(19) United States
(12) Patent Application Publication
(10) Pub. No.: US 2010/0032400 A1
(43) Pub. Date: Feb. 11, 2010

(54) Two part vessel with a hingeable actuator for a cutter

(76) Inventors: David A. James, Victoria (AU); Stephen Wilson, Victoria (AU); Andrew M. Angus, Victoria (AU); Robert A. Neil, Victoria (AU)

Correspondence Address: MCHALE & SLAVIN, P.A., 2855 PGA BLVD, PALM BEACH GARDENS, FL, 33410, US

(21) Appl. No.: 12/375,540

(22) PCT Filed: Jul. 30, 2007
(86) PCT No.: PCT/AU07/01057

§ 371 Date: Jul. 15, 2009

(30) Foreign Application Priority Data
Jul. 31, 2006 (AU) 2006904129

(51) Int. Cl. B65D 51/00; B23P 19/04

(52) U.S. Cl. 215/227; 29/700

(57) ABSTRACT

An assembly for location at an opening of a receptacle, the assembly including: a lid including an envelope attached thereto wherein the envelope includes a substance contained therein; and, an envelope opening means including a protrusion coupled to an actuator, wherein movement of the lid relative to the receptacle operates the actuator causing the protrusion to open the envelope releasing the substance into the receptacle.

The present invention relates to an assembly for location at an opening of a receptacle and in particular to an assembly that allows the storage and subsequent controlled mixing of a substance with another substance contained in the receptacle.

### BACKGROUND OF THE INVENTION

International Patent application WO 2004/033336 (the subject matter of which is contained herein by reference) describes a device for location at the opening of a receptacle that in use allows a user to open the top of a receptacle and in the same movement dispense a second substance, such as an effervescent tablet into the drink container. Prior to opening, the second substance is contained within a compartment that is integral with the lid of the device. The action of removing the lid from the bottle also activates a cutting mechanism which opens a foil seal covering the compartment and thereby releasing the substance contained therein. However, there are a number of problems associated with this design, particularly when looking at issues of mass production of high volume beverage and/or food products.

In particular, the compartment whilst providing a storage solution separate from that of the contents contained within the main body of the receptacle, does not provide an easily sanitised environment as required by the food and beverage industry. In order to use the device of WO 2004/033336, rigorous sanitation of the compartment is required in order to meet food and beverage guidelines for storing a food or beverage substance. Furthermore, the main compartment, aside from the foil seal, is composed from plastic. Moisture ultimately has a tendency to ingress through plastic. Therefore, if the device as described in WO 2004/033336 was used to store a moisture sensitive substance, such as an effervescent tablet within the compartment, the shelf life may be unsuitably short due to the necessity to provide a dry environment for the substance.

In addition, the cutting portion associated with the design of WO 2004/033336 is pushed into the engagement position once the lid is rotated about the receptacle. However, the cutting portion has a tendency to drop out of cutting engagement with the foil seal surrounding the compartment, thereby not completely releasing the contents contained within the compartment.

Accordingly, the present invention seeks to address the disadvantages associated with the device described above and in particular provide an assembly that significantly addresses the issues of mass production in the food and beverage industry.

### SUMMARY OF THE INVENTION

According to one aspect the present invention provides an assembly for location at an opening of a receptacle, the assembly including:
a lid including an envelope attached thereto wherein the envelope includes a substance contained therein; and,
an envelope opening means including a protrusion coupled to an actuator, wherein movement of the lid relative to the receptacle operates the actuator causing the protrusion to open the envelope releasing the substance into the receptacle.

According to one form, the actuator includes a flange that is hingedly coupled to the protrusion wherein movement of the lid relative to the receptacle causes the flange to move and bias the protrusion into a position that opens the envelope.

Preferably the protrusion includes a cutter portion that is adapted to cut at least a substantial opening in the envelope to assist in the releasing of the substance. Preferably once the flange is moved to bias the protrusion into a position that opens the envelope, the flange is retained in an engaged position by retaining means such that the protrusion is maintained in a contacting position with the envelope during further movement of the lid relative to the receptacle.

Preferably, the envelope is preformed prior to attaching the envelope to the lid. According to this aspect the substance may be kept in a sanitised environment within the envelope prior to being incorporated into the lid of the assembly. The surface of the envelope to be opened may be composed of any suitable material that may be opened by the protrusion either by a piercing and/or cutting action. Preferably, the surface of the envelope to be opened is composed of a material that provides a moisture barrier, such as for example foil or a laminate including a foil layer, and more preferably the entire envelope is composed of such a material. Preferably the envelope is substantially circular in shape and is produced by sealing the outer circumferential portions of two substantially circular planar portions with the substance contained within the envelope positioned between the two substantially circular planar portions.

Alternatively, the envelope includes a bottom surface and a top surface capable of being opened by the protrusion wherein the bottom surface is sealed to the top surface creating a void therebetween with the substance contained in the void. According to this form, the bottom surface is substantially semi spherical or substantially bulbous in shape with a circumferential edge portion which is in contact and sealed to the top surface.

Preferably, the lid includes a receiving portion within which the envelope is attached. Preferably, the receiving portion includes a series of castellations in a substantially circular configuration defining the outer circumferential area of the receiving portion. Preferably the edge portion of the envelope is attached to the castellations. According to this form, the castellations provide a pathway for a liquid or fluid to pass into the receiving portion whilst the envelope is attached thereto. As such, a sanitising fluid such as ozonated water may be used to sanitise the assembly with the envelope in place just prior to the assembly being positioned on the receptacle during a bottling process.

Preferably, the lid is adapted for threadable engagement with the opening of the receptacle whereby rotation of the lid in a first direction attaches the lid to the receptacle thereby covering the opening of the receptacle. Preferably, rotation of the lid in a second opposite direction detaches the lid from the receptacle and also corresponds to movement of the lid relative to the receptacle that operates the actuator causing the protrusion to open the envelope releasing the substance into the receptacle.

Preferably the protrusion is part of an insert that is positionable in a neck of the receptacle. More preferably, the insert is a sleeve positionable in a neck of the receptacle and the protrusion is positioned inwardly from the sleeve.

Preferably the sleeve further includes:
a mounting that attaches the sleeve to the lid and allows rotation of the sleeve in an axially fixed manner relative to the lid;
retaining means located on the outward surface of the sleeve for holding the sleeve in a frictional engagement at the opening of the receptacle; and,
a flange located on an interior or exterior surface of the sleeve which is arranged to abut a corresponding flange on the lid, wherein when the lid is rotated and the flange located on the sleeve abuts the flange located on the lid, the sleeve and lid rotate together but only as allowed by the frictional engagement of the retaining means.

According to a further aspect, the present invention provides a process for producing the assembly as herein described including the following steps:
(a) producing the envelope with a substance contained therein;
(b) attaching the envelope to the lid;
(c) optionally sanitising and/or sterilising the assembly.

### BRIEF DESCRIPTION OF THE DRAWINGS

The present invention will become better understood from the following detailed description of the preferred but non-limiting embodiments thereof, described in connection with the accompanying figures, wherein:

FIG. 1 is a cross sectional perspective view of a two part vessel including an assembly in accordance with one aspect of the present invention;

FIG. 2 is an exploded view of the assembly in accordance with one aspect of the present invention;

FIG. 3 is a perspective view of the lid in accordance with the present invention;

FIG. 4 is a perspective view of the sleeve displaying the protrusion and actuator in accordance with one aspect of the present invention; and,

FIG. 5 is a perspective view of the assembly in accordance with another aspect of the present invention.

### DETAILED DESCRIPTION OF THE INVENTION

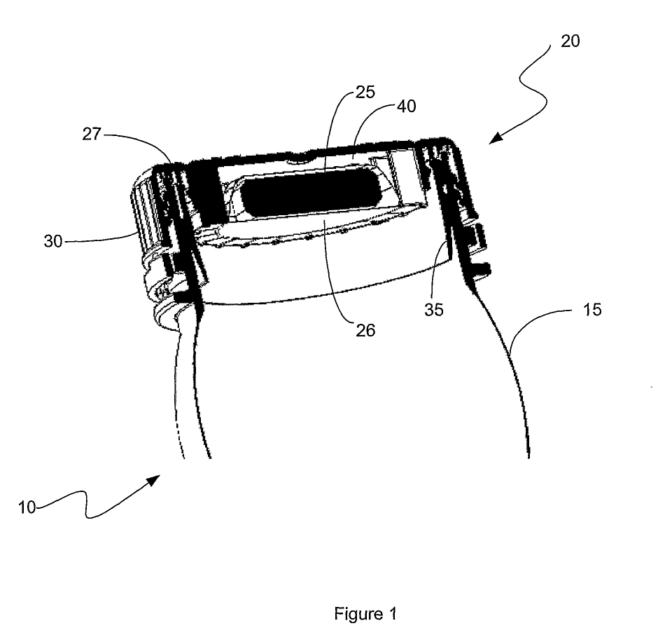

Referring to FIG. 1, there is shown a two part vessel generally at 10 which includes a bottle or receptacle 15 for containing a liquid substance and a top assembly 20 which contains a solid substance 25 attached to a receiving portion within the lid 30. In this embodiment, the solid substance is in the form of an effervescent tablet 25. The substance is encased within an envelope 26 that is attached to the inside surface of the lid 30.

The top assembly 20 includes a lid portion 30, a sleeve portion 35 that is attached to the underside of the top surface 27 of the lid portion 30 and extends into the neck portion of the bottle 15. The substance 25 in the envelope 26 is fixed to the receiving portion 40 of the lid 30 by means of an adhesive.

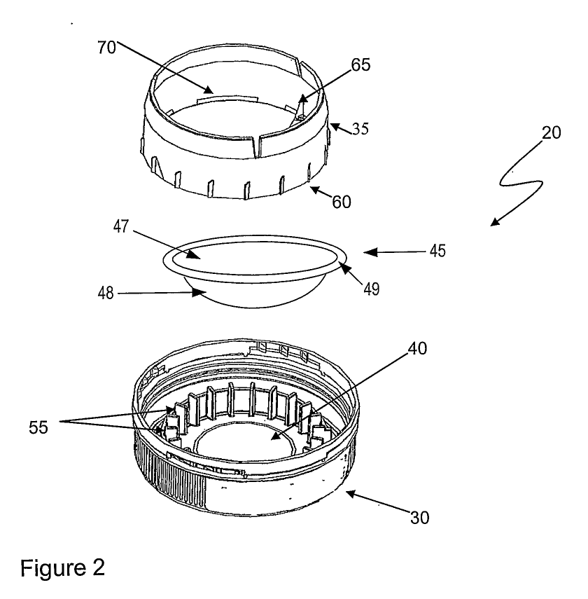

Referring now to FIG. 2, there is shown an exploded diagram of the top assembly 20 in accordance with one embodiment of the present invention. Here the envelope 45 encasing the effervescent tablet is shown separated from the lid 30. The envelope 45 in this instance is composed of foil on a top surface 47 and a bottom surface 48 composed of laminate and foil combination. The materials of the envelope 45 provide a moisture barrier around the entirety of the effervescent tablet.

The bottom surface 48 of the envelope 45 in this embodiment is in a substantially semi circular or bulbous shape which includes an edge portion 49. The top surface 47 is sealed onto the bottom surface 48 around the edge portion 49 with the effervescent tablet encased within the envelope 45. The bottom surface 48 is fixed within the lid 30 in the receiving portion 40 by means of an adhesive and the sealed edges 49 of the envelope 95 are attached to the castellations 55 that are appearing around the outside of the receiving portion 40 also by means such as an adhesive.

The envelope 45 encasing the effervescent tablet provides significant advantages in that the tablet is encased separately and can be attached in place after the formation and sanitisation of the other components of the assembly, which may be necessary when producing a beverage product on a mass produced scale.

Furthermore, by attaching the sealed portion 49 of the envelope 45 to the top of the castellations 55, it is possible to allow the passage of liquid or fluid, such as ozonated water, and sanitise underneath the foil envelope 45 of the entire receiving portion 40.

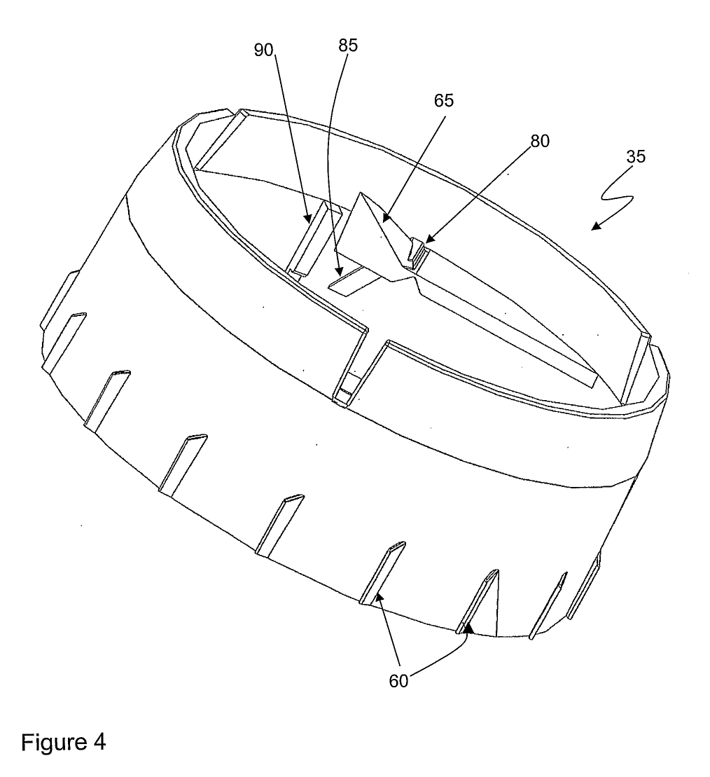

Referring to the sleeve 35 in FIGS. 2 and 4, there is shown mounting means 70 consisting of a flange portion which cooperates with a similarly arranged flange portion on the inside surface of the lid 30 circumferentially external to the receiving portion 40. When the mounting means 70 of the sleeve 35 is engaged with the corresponding flange portion of the lid, this allows rotational movement of the sleeve 35 around the receiving portion 40 in a fixed axial manner.

The sleeve 35 further includes retaining means 60 which hold the sleeve in frictional engagement at the opening of the receptacle 15 when the lid 1 is in place at the top of the bottle 15.

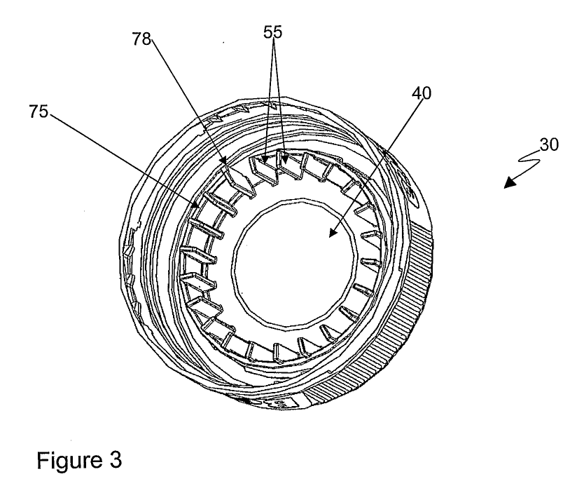

Referring now to FIGS. 2 and 3, there is shown the lid portion of the assembly. The lid portion 30 includes a receiving portion 40 where the envelope including the effervescent tablet (not shown) may be fixed with glue or other suitable fixing or attachment means such as for example ultrasonic welding or heat sealing. Furthermore, the edges of the sealed portion of the envelope 49 (see FIG. 2) can be attached to the top of the castellations 55 allowing a passage behind the envelope if required for sanitation purposes during assembly or a production line. In addition, there is shown at 75 a retaining ledge for maintaining the actuator 85 (see FIG. 4) in an engaged position whereby the protrusion 65 and cutting portion of the protrusion 65 are kept in constant engagement with the foil envelope 45 whilst cutting around releasing the effervescent tablet.

At 78 there is also shown a flange which cooperates with a corresponding flange 90 on the sleeve portion 35. When flange 78 is in contact and abutting the flange on the sleeve portion 90 rotation of the sleeve about the lid is prevented thereby allowing removal of the lid from the bottle.

Referring now to FIG. 4, there is shown the sleeve portion 35 of the assembly. In particular, this view of the sleeve portion 35 shows the cutter protrusion 65 in a hinged relationship with the actuator 85. The hinge 80 allows the protrusion to move between a cutting position (not shown) and the unengaged position (shown). FIG. 4 also depicts a flange 90 attached to the sleeve which corresponds to the flange 78 on the lid portion and inhibits rotational movement of the sleeve about the lid portion.

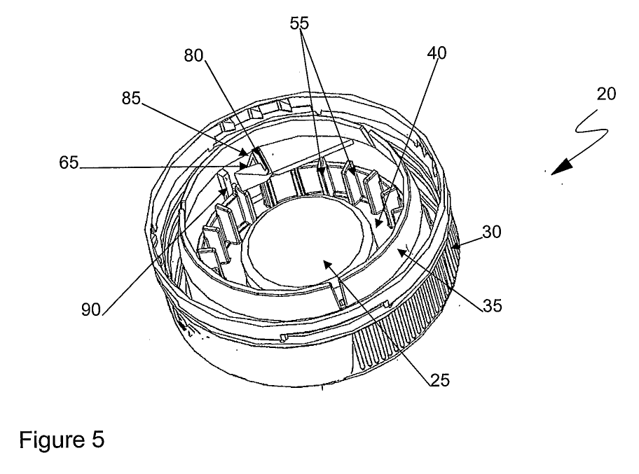

In use and referring again to FIGS. 1 to 5, the top assembly is attached to a bottle 15 during assembly and filling of the bottle with a liquid. Prior to opening the lid, the actuator 65 rests in an open position between two castellations which do not include the retaining ledge 75 thereby retaining the protrusion 65 in a position that does not touch or open the top surface 47 of the envelope. Upon rotation of the lid 30 relative to the bottle 15, the sleeve is held in place through frictional engagement with the neck of the bottle 15 whilst the lid rotates around. The retaining means 70 and corresponding flange arrangement 78 in the lid allow the rotational movement of the lid relative to the sleeve in a fixed axial manner. Upon movement of the lid, the actuator 85 which is fixed to the sleeve 60 is moved up onto the retaining ledge 75 of the lid in an upward position thereby forcing the protrusion including a cutting surface also attached to the sleeve 60 into an opening position. Upon further rotation of the lid the protrusion cuts an arc along the foil top portion 47 of the envelope 45 opening up the envelope and allowing the contents to drop into the liquid contained within the bottle 15.

The actuator 85 of the sleeve 60 is maintained in an engaged position by the retaining ledge 75 of the lid 30 whilst the lid 30 is rotating relative to the sleeve 60 held in place in the neck of the bottle until flange 90 is abutting flange 78 of the lid 30. At this point, the further rotation of the lid overcomes the frictional force of the sleeve 60 held within the neck of the bottle 15 wherein the sleeve portion 60 now moves together with the lid 30 allowing the assembly to be removed from the receptacle. In this manner, the contents of the envelope 45 may be emptied into the liquid contained within the bottle 15 in the same motion as removing the top assembly 20 from the bottle 15 to gain access to the liquid contained therein.

Finally, it is to be understood that various alterations, modifications and/or additions may be incorporated into the various constructions and arrangements of parts without departing from the spirit or ambit of the invention.

1. An assembly for location at an opening of a receptacle, the assembly including:
a lid including an envelope attached thereto wherein the envelope includes a substance contained therein; and,
an envelope opening means including a protrusion coupled to an actuator,
wherein movement of the lid relative to the receptacle operates the actuator causing the protrusion to open the envelope releasing the substance into the receptacle.

2. An assembly according to claim 1 wherein the actuator includes a flange that is hingedly coupled to the protrusion wherein movement of the lid relative to the receptacle causes the flange to move and bias the protrusion into a position that opens the envelope.

3. An assembly according to claim 2 wherein once the flange is moved to bias the protrusion into a position that opens the envelope, the flange is retained in an engaged position by a retaining means such that the protrusion is maintained in an opening position with the envelope during movement of the lid relative to the receptacle.

4. An assembly according to claim 1 wherein the protrusion includes a cutter portion that is adapted to cut an opening in the envelope to assist in the releasing of the substance into the receptacle.

5. An assembly according to claim 1 wherein the movement of the lid relative to the receptacle is in the form of rotational movement.

6. An assembly according to claim 4 wherein the cutter portion is adapted to cut an arcuate opening in the envelope upon movement of the lid relative to the receptacle in a rotational manner.

7. An assembly according to claim 1 wherein the envelope is preformed prior to attachment to the lid.

8. An assembly according to claim 1 wherein the envelope includes a bottom surface and a top surface capable of being opened by the protrusion wherein the bottom surface is sealed to the top surface creating a void therebetween with the substance contained in the void.

9. An assembly according to claim 8 wherein the bottom surface is substantially semi spherical or substantially bulbous in shape with a circumferential edge portion which is in contact and sealed to the top surface.

10. An assembly according to claim 8 wherein the top surface is substantially flat and in the same plane as circumferential edge portion of the bottom surface.

11. An assembly according to claim 8 wherein the envelope is composed of a material that provides a moisture barrier.

12. An assembly according to claim 8 wherein the top surface is composed of foil optionally including a further laminate layer.

13. An assembly according to claim 8 wherein the bottom surface is composed of foil optionally including a further laminate layer.

14. An assembly according to claim 1 wherein the lid includes a receiving portion within which the envelope is attached.

15. An assembly according to claim 14 wherein the receiving portion includes a plurality of castellations in a substantially circular configuration defining the outer circumferential area of the receiving portion.

16. An assembly according to claim 15 wherein the edge portion of the envelope is attached to the castellations and/or a base of the receiving portion, thereby providing a pathway for fluid to pass between the castellations.

17. An assembly according to claim 1 wherein the lid is adapted for threadable engagement with the opening of the receptacle whereby rotation of the lid in a first direction attaches the lid to the receptacle thereby covering the opening of the receptacle and, rotation of the lid in a second opposite direction detaches the lid from the receptacle and also corresponds to movement of the lid relative to the receptacle that operates the actuator causing the protrusion to open the envelope releasing the substance into the receptacle.

18. An assembly according to claim 1 wherein the protrusion is part of an insert that is positionable in a neck of the receptacle.

19. An assembly according to claim 18 wherein the insert is a sleeve positionable in a neck of the receptacle and the protrusion is positioned inwardly from the sleeve.

20. An assembly according to claim 19 wherein the sleeve further includes:
a mounting that attaches the sleeve to the lid and allows rotation of the sleeve in an axially fixed manner relative to the lid;
retaining means located on the outward surface of the sleeve for holding the sleeve in a frictional engagement at the opening of the receptacle; and,
a flange located on an interior or exterior surface of the sleeve which is arranged to abut a corresponding flange on the lid, wherein when the lid is rotated and the flange located on the sleeve abuts the flange located on the lid, the sleeve and lid rotate together but only as allowed by the frictional engagement of the retaining means.

21. A process for producing the assembly according to claim 1 including the following steps:
(d) producing the envelope with a substance contained therein;
(e) attaching the envelope to the lid;
(f) optionally sanitising and/or sterilising the assembly.
